(19) United States
(12) Patent Application Publication
(10) Pub. No.: US 2005/0176463 A1
(43) Pub. Date: Aug. 11, 2005

(54) Method and system for communicating wirelessly between devices

(75) Inventors: Gerrit Hollemans, Eindhoven (NL); Peter Tjin Sjoe kong Tsang, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., 5621 BA Eindhoven (NL)

(21) Appl. No.: 10/520,868

(22) PCT Filed: Jun. 25, 2003
(86) PCT No.: PCT/IB03/02699

(51) Int. Cl. H04M 1/00

(52) U.S. Cl. 455/557

(57) ABSTRACT

The invention relates to a method and a system (200) for communicating wirelessly between devices. Wireless communication can be a very appropriate way of interconnecting nearby devices, such as devices located within a home. However, equipping all devices with a wireless transceiver may not be desirable. Furthermore, an ordinary user should be able to connect devices in a straightforward and convenient way. The invention addresses these issues by means of a wireless communication key (250, 260, 270). This is a key-like object equipped with a transceiver. A key can be attached to a device (220, 230, 240) for which a wireless connection is required. A key may have to be powered by the device to which it gets attached and can then establish a wireless connection (280, 282) with another device. The other device is determined by the key used. A key may be associated with a fixed endpoint device (210), permanently equipped with a transceiver (212). Alternatively, a key may be associated with a second key that is to be attached to the other device.

The invention relates to a method for communicating wirelessly between a first device and a second device.

The invention also relates to a system arranged for communicating wirelessly between a first device and a second device.

Situations exist where devices need to be connected that are at different nearby locations, for example in different rooms of a home. In a number of cases, a permanent connection between devices is not needed, for example because a device, when considered over a longer period of time, typically only requires a connection to another device for a well defined very short part of that period, for example to communicate a single piece of measurement data only once. Also, a permanent connection may not be desirable from the viewpoint of a user of a device, who may want to have explicit control and visual feedback with respect to when a connection between devices can be established. Still, a convenient and cost-effective way to instantly make a connection between devices is needed. One way to achieve this is to use wireless communication, for example by means of a radio interface, using radio frequency (RF) transceivers. Considering a situation with a system in which several different devices all need a connection to a single, fixed endpoint device, it makes sense to construct this endpoint device with a transceiver for wireless communication. However, it may not be desirable to construct each of the aforementioned group of several different devices with a transceiver too. One reason for this can be the associated costs of such a transceiver, especially when that cost is high compared to the overall cost of a device. Also the number of devices that each would require a transceiver may play a role here. Another reason for not including a transceiver in every device may be because of resulting system configuration and device connection setup complexity for an ordinary user of a system. Especially for wired and wireless networks of devices, problems in this area are quite well known, and often require the assistance of experts in this area in order to be solved. Again considering a system with a single, fixed endpoint device and a group of devices that at times require a connection to the endpoint device, it may be very difficult for an ordinary user to properly configure the devices for the required connections to the endpoint device. This may be especially so, if the system was purchased and assembled over time, with new devices being added to an already operational system. In addition, device connection setup issues may arise for every time that a connection between devices is needed, and where a user, for example, is required to specify the use of a particular endpoint device required for a connection. Such a device specification may be very annoying to a user. It may also require specific means for user interaction, such as for example a screen and buttons, that are otherwise not needed for a particular device.

It is therefore an object of the invention to provide a method for communicating wirelessly between a first device and a second device, where it is not necessary that both devices are constructed to include a transceiver and where the corresponding wireless connection can be made in a straightforward and convenient way by an ordinary user of the devices.

According to a first aspect of the invention the method comprises a first step of providing a wireless communication key, comprising a first transceiver conceived for communicating wirelessly with a second transceiver included in the second device, a second step of operatively attaching the wireless communication key to the first device, and a third step of the first device utilizing the attached wireless communication key for establishing wireless communication between the first device and the second device. Here only the second device is constructed to include a transceiver and the invention introduces the concept of a wireless communication key, also sometimes referred to as simply a key in this text. A wireless communication key is a relatively small separate physical object equipped with a transceiver for wireless communication. The transceiver covers a transmission range suitable for the intended application of the key. In the above situation, where a connection to a fixed endpoint device is needed, a key is assigned to the endpoint device, which implies that the transceiver of the key will always communicate with the transceiver included in the endpoint device. By operatively attaching the key to a device that needs to communicate with the endpoint device, a wireless connection between the two devices gets established. Operatively attaching a key to a device may be done in various ways, for example by inserting the key in a special slot or socket available at the device for that purpose. A key does not itself have to contain a power source, such as for example a battery, for operating the transceiver contained in the key. Instead, the power required for operating the transceiver may have to be supplied by the device to which the key gets attached.

In general, not just a single wireless communication key need be assigned to a given endpoint device. Instead, multiple keys may be assigned to the same endpoint device and may be in use at the same time or at different times. Such a setup allows for systems in which for example the endpoint device may act as a base station, for example for data storage, and the devices to which a key gets attached act as sensors. In the case of multiple keys it may also be advantageous if a key contains a unique identification, where this identification may be communicated wirelessly to the endpoint device to which the key has been assigned, and may also be accessed by the device to which the key gets attached. By means of the identification it is possible to uniquely identify a particular key, and to discriminate that key from other such keys also in use. The identification contained in a key may be used by a system for the purpose of identification and/or authorization of a known user or owner of the key. One example of this may be the association of data that gets communicated via a particular key with a person that is known to a system to be the owner or current user of that key.

According to a second aspect of the invention the method comprises a first step of providing a first wireless communication key and a second wireless communication key, each one of said keys comprising a transceiver conceived for communicating wirelessly with the transceiver included in the other key, a second step of operatively attaching the first wireless communication key to the first device and the second wireless communication key to the second device, and a third step of the first device and the second device utilizing said respective attached wireless communication keys for establishing wireless communication between the first device and the second device. Here none of the two devices is constructed to include a transceiver. Also in a situation where there is no fixed endpoint device, it may still be desirable to be able to have a wireless connection between two devices that each do not have a transceiver of their own. For use in such a situation, the invention introduces a pair of wireless communication keys. The two keys that form a pair are assigned to each other, which implies that these keys will always communicate with each other. By operatively attaching each of the two keys to a respective device, a wireless connection between the two devices gets established.

Multiple pairs of wireless communication keys may be in use at the same time, without interfering with each other. In order to know which keys form a pair, keys pairs should be made distinguishable from each other, for example by their shape, by labeling the keys as such, or by using different colors for different key pairs.

Within the context of the present invention a first device can only communicate with a second device when, in the case of an endpoint device as the second device, a single wireless communication key gets attached to the first device, or, in the case of a pair of keys, both keys get attached to the respective devices. Consequently, the presence (or absence) of any such keys provides for clear user control and feedback as to which devices are able to communicate wirelessly at any particular moment in time. This not only holds for the establishment of a wireless connection, by operatively attaching a wireless communication key, but also applies to terminating such a connection, by means of a user removing a key from a device to which the key was previously attached.

In a first embodiment, the system according to the invention is characterized in that it comprises a wireless communication key, comprising a first transceiver conceived for communicating wirelessly with a second transceiver included in the second device, first means for operatively attaching the wireless communication key to the first device, and second means for the first device utilizing the attached wireless communication key for establishing wireless communication between the first device and the second device. As such, this system is particularly suited for use in a personal health coach.

In a second embodiment, the system according to the invention is characterized in that it comprises a first wireless communication key and a second wireless communication key, each one of said keys comprising a transceiver conceived for communicating wirelessly with the transceiver included in the other key, first means for operatively attaching the first wireless communication key to the first device, second means for operatively attaching the second wireless communication key to the second device, and third means for the first device and the second device utilizing said respective attached wireless communication keys for establishing wireless communication between the first device and the second device. As such, this system is particularly suited for use in a remote video camera system.

The invention will be further elucidated and described with reference to the drawings, in which:

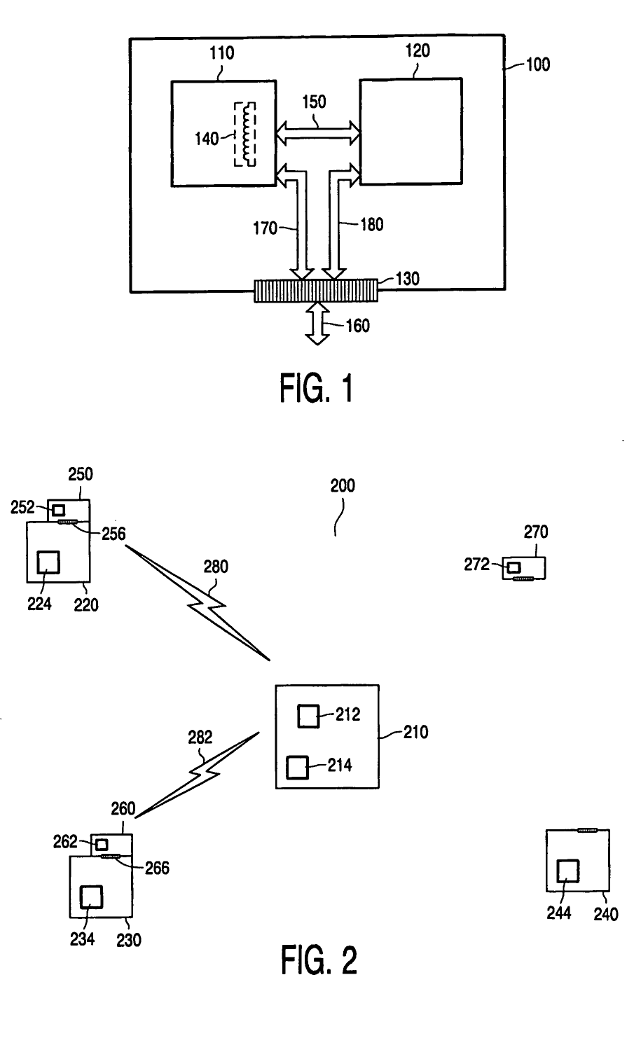

FIG. 1 illustrates, in a schematic way, the most important parts of an embodiment of a wireless communication key for use in the method and the system according to the invention;

FIG. 2 illustrates, in a schematic way, the most important parts of a first embodiment of the system according to the invention, making use of a fixed endpoint device;

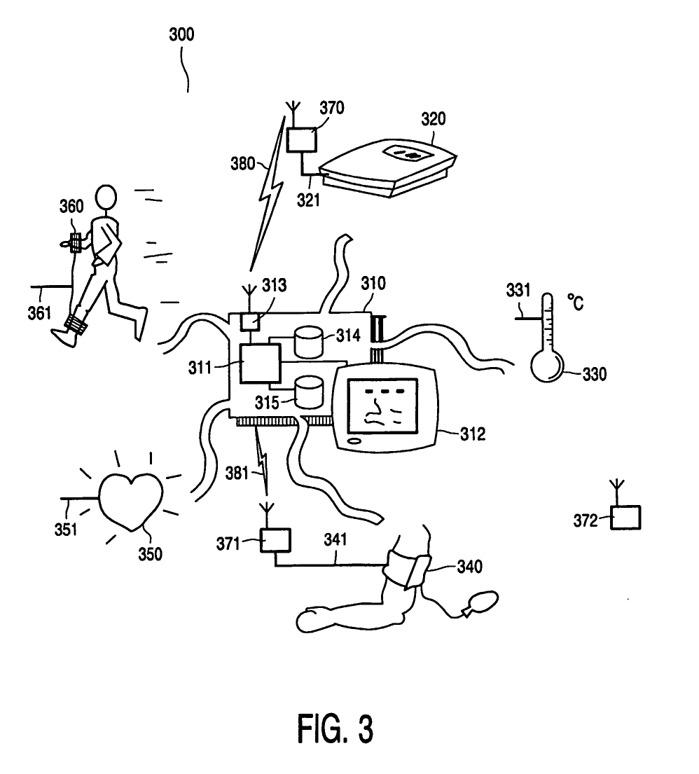

FIG. 3 illustrates, in a schematic way, the most important parts of a personal health coach comprising a second embodiment of the system according to the invention, also making use of a fixed endpoint device;

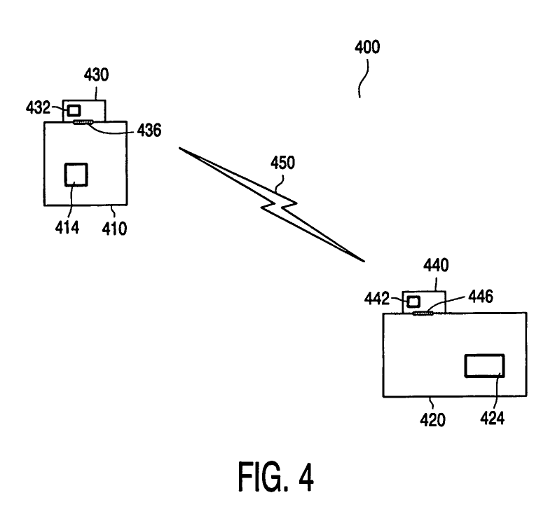

FIG. 4 illustrates, in a schematic way, the most important parts of a third embodiment of the system according to the invention, making use of a pair of wireless communication keys;

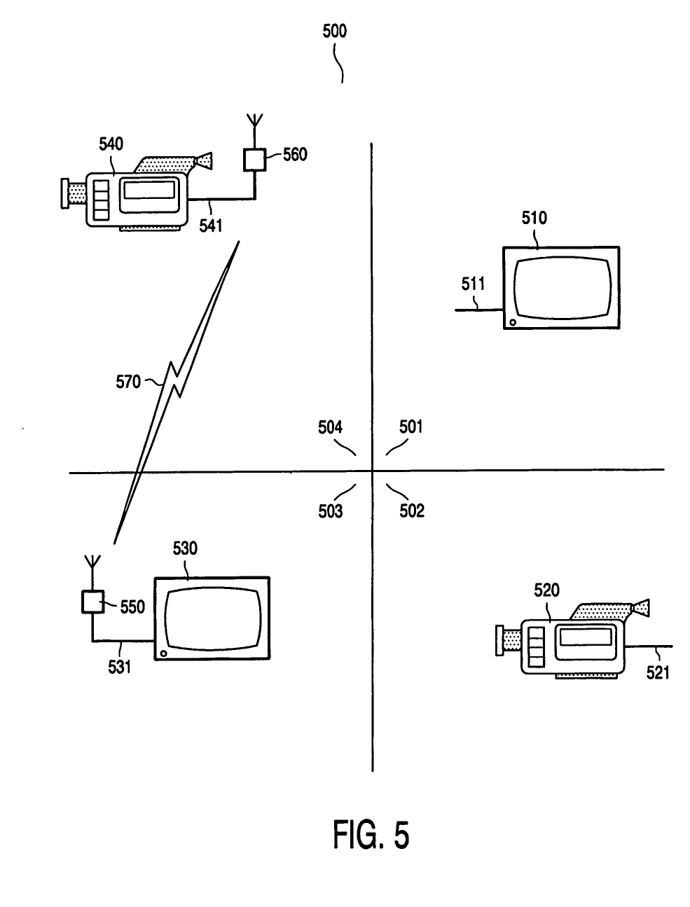

FIG. 5 illustrates, in a schematic way, the most important parts of a remote video camera system comprising a fourth embodiment of the system according to the invention, also making use of a pair of wireless communication keys;

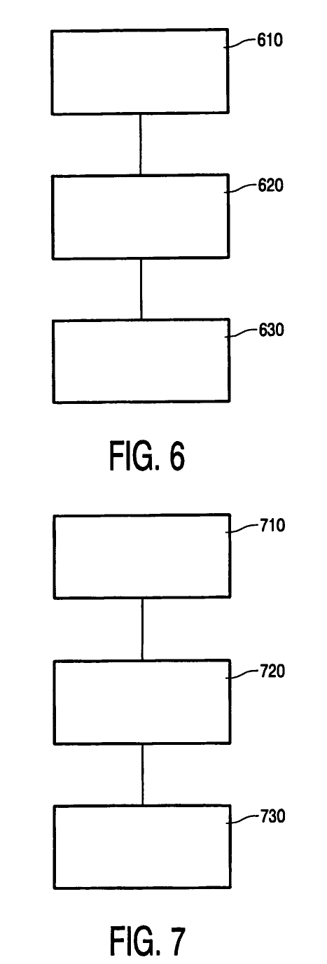

FIG. 6 illustrates, in a schematic way, a first embodiment of the method according to the invention, making use of a fixed endpoint device;

FIG. 7 illustrates, in a schematic way, a second embodiment of the method according to the invention, making use of a pair of wireless communication keys.

FIG. 1 illustrates, in a schematic way, the most important parts of an embodiment of a wireless communication key for use in the method and the system according to the invention. A wireless communication key 100 includes a RF transceiver unit 110. In the present embodiment, an antenna 140 forms an integral part of the transceiver 110. In other embodiments, the antenna 140 and the transceiver 110 may also be separate parts. The transceiver 110 provides for a wireless connection between itself and a second transceiver (not shown in FIG. 1). Such a wireless connection can be established in several different ways, for example by using a radio interface or by using a light interface, such as for example infra-red (IR). The use of a light interface may work well for very short range and line-of-sight wireless connections. For most situations however, the use of a radio interface may be more suitable or may even be required. As already indicated, the present embodiment uses a radio interface, for which a widely known Wireless Local Area Network (WLAN) technology may be used, such as for example IEEE 802.11, HomeRF, or ZigBee. For relatively short-range wireless connections, also a Wireless Personal Area Network (WPAN) technology like for example Bluetooth may be used. Also, for security and privacy reasons, the wireless communication may be encrypted.

Within the wireless communication key 100, the transceiver 110 is connected to a storage 120 via an interface 150. Among other things, the storage 120 may hold transceiver configuration information, relating to the establishment of a wireless connection for the key 100, and this may include information about the assignment of the key 100 with either an endpoint device or a second key (both not shown in FIG. 1). Referring to the aforementioned wireless networking technologies, such an assignment may be by way of a Media Access Control (MAC) address of the second transceiver involved, either from an endpoint device or a second key.

The wireless communication key 100 furthermore includes a connector 130, for operatively attaching the key 100 to a device that requires a key for its communication (not shown in FIG. 1). The connector 130 may be realized by means of a dedicated connector, specifically designed for use with a key. However, the connector 130 may also be based on a widely known connection technology, such as for example a RS-232 serial connector, an USB connector, or even a PC-Card connector. Advantages of using a RS-232-like connector may be that such connectors are relatively straightforward and very cheap. However, these connectors do not normally provide for specific power supply connections, that may be required to power a key. Power supply connections are standard for the more expensive USB and PC-Card connectors. Besides using these connector types, other means of operatively attaching a key to a device may also be used. One example may be the use of a conductive hook and loop fastener between a device and a key. The connector 130 provides an external interface 160. Within the key 100, the connector 130 also provides an interface 170 to the transceiver 110 and an interface 180 to the storage 120. The external interface 160 may be used to supply power to the key 100. Furthermore, the interface 160 is used for the exchange of data between the key 100 and a device to which the key 100 gets attached. Such data includes data to be transmitted or data received by the transceiver 110, also using the interface 170. The interfaces 160 and 180 provide external access to the storage 120. During manufacture of the key 100, but also afterwards, this external access via the interfaces 160 and 180 may be used for the placement of transceiver configuration information in storage 120, to configure the key 100 with respect to its assignment to a fixed endpoint device or a second key. Once more referring to the aforementioned wireless networking technologies, this may be by way of the Media Access Control (MAC) address of the second transceiver involved.

The storage 120 may also hold a unique identification of the wireless communication key 100. This identification may be passed over a wireless connection via the interface 150 and the transceiver 110, and may then be used to uniquely identify this particular key 100 in the presence of other such keys. Via the interfaces 160 and 180, this identification may also be accessed by a device to which the key 100 gets attached. Similar to the aforementioned placement of transceiver configuration information in the storage 120, the same interfaces 160 and 180 may also be used to place an unique identification for the key 100 in the storage 120.

Besides the parts shown for the wireless configuration key 100 in FIG. 1, several extensions to a key are possible that may have an added value for a user of such a key, also in situations where the key is not at that time used for communication, and is not attached to a device. If equipped with a limited local power source, such as a small battery, which is not to be used for operating the transceiver 110, the key 100 may for example also comprise a digital clock, for showing the time to a user. In combination with the storage 120 and visual and/or audible signaling means, such a key may also be useful for generating reminders to a user. The storage 120 may also be used to store data received from a device to which the key 100 gets attached, or data received via the transceiver 110 during a wireless connection. At some later moment in time, such data may then be made available to another device to which the key 100 gets attached or serve some other purpose. Also buffering of data to be transmitted in the storage 120 may be a solution for situations in which wireless communication is temporarily not possible, for example because the second device is temporarily out of reach for the transmitter 110.

FIG. 2 illustrates, in a schematic way, the most important parts of a first embodiment of the system according to the invention, making use of a fixed endpoint device. A system 200 comprises a fixed endpoint device 210. This endpoint device 210 comprises a transceiver 212 and a control unit 214 for operating the transceiver 212 and possibly other parts of the endpoint device 210 as well. Besides the endpoint device 210, the system 200 further comprises devices 220, 230, and 240, all of them suited for operation with a wireless communication key. In particular, each of the devices 220, 230, and 240 comprises a respective control unit 224, 234, and 244 for operating an attached key. The system 200 also comprises keys 250, 260, and 270, where each of these keys comprises a respective transceiver 252, 262, and 272. The keys 250, 260, and 270 have all been assigned to the endpoint device 210, which implies that each of the transceivers 252, 262, and 272, contained in the respective keys, is able to establish a wireless connection with the transceiver 212 of the endpoint device 210, provided that such a key gets attached to a device.

In the system 200, the wireless communication key 250 has been attached to the device 220 by means of the connection 256. It is therefore possible for the control unit 224 of the device 220 to operate the key 250, and in particular the transceiver 252, and in this way establish a wireless connection 280 with the endpoint device 210, which uses the transceiver 212 and the control unit 214 for this purpose. In a very similar way, the device 230 may operate the key 260 for communicating with the device 210 over a wireless connection 282. On the other hand, the device 240 has no key attached to it, and has therefore not a wireless connection with the endpoint device 210. Furthermore, the key 270 has not been attached to a device of the system 200.

FIG. 3 illustrates, in a schematic way, the most important parts of a personal health coach comprising a second embodiment of the system according to the invention, also making use of a fixed endpoint device. A personal health coach is a system for normal healthy people that are interested in maintaining or improving their physical condition. For that purpose the personal health coach informs a user about his current health situation and also advises the user on nutrition and fitness activities to undertake. To make this possible, the personal health coach receives the results of various physical measurements pertaining to a user, such as body temperature, body weight, heartbeat, blood pressure, and activities performed. Based on these results, and in particular observed trends in these results, the personal health coach is able to offer the aforementioned information and advise. A personal health coach is typically used in a home setting, where one or more persons of a household may use it.

Shown in FIG. 3 is a personal health coach 300 comprising a base station 310 and various measuring devices 320, 330, 340, 350, and 360. The base station 310 constitutes the main component of the personal health coach 300. The base station 310 as shown here comprises a processing unit 311, a display device 312, a wireless transceiver 313, a database 314 of physical measurement data, and a knowledge base 315 comprising rules for the processing and interpretation of physical measurement data. Among other things, the processing unit 311 maintains the database 314 and uses the knowledge base 315. Furthermore, the processing unit 311 may inform or advise a user with respect to his health situation via the display device 312. In terms of the present invention, the base station 310 comprises a fixed endpoint device that is permanently equipped with a transceiver 313.

Not shown in FIG. 3, but very well possible in a typical home setting is a connection of the base station 310 to a home network, such as for example an Ethernet or an IEEE 1394 network. Via the network, the base station 310 may also be able to provide a user with information on a display device connected to the network, such as for example a TV-set. In this way a user of the personal health coach 300 is no longer dependent on the display device 312 for his information. The user may then consider placing the base station 310 in a somewhat out of sight location in his home, such as a cupboard, a cellar, or an attic.

The physical measurement data for the database 314 is to be supplied by the measurement devices 320, 330, 340, 350, and 360. The device 320 comprises a pair of scales for measuring body weight, the device 330 comprises a thermometer for measuring body temperature, the device 340 comprises a blood pressure meter, the device 350 comprises a heartbeat monitor, and the device 360 comprises a set of activity sensors for measuring bodily activities. It is to be understood that FIG. 3 depicts these devices in a very symbolic way only as the emphasis instead is placed upon illustrating the principles of the invention. Although shown together in FIG. 3, the devices 320, 330, 340, 350, and 360 may be scattered in and around a home, with for example the device 320 located in a bathroom and the devices 340 and 350 located in a training room, whereas the device 330 has no specific location at all. A device may also be worn by a user for a considerable length of time, which may here be the case for the device 360. In terms of the present invention, each of the devices 320, 330, 340, 350, and 360 comprises a device that does not have a transceiver of its own and is instead constructed to use a wireless communication key. For the devices 320, 330, 340, 350, and 360, a key is to be attached via connectors 321, 331, 341, 351, and 361 respectively. This too is only shown in a symbolic way in FIG. 3.

It is furthermore to be noticed that the devices 320, 330, 340, 350, and 360 correspond with well known measurement devices to which support for a wireless communication key has been added. In this way, a user gets easily acquainted with the measurement devices, and also has a clear picture of what measurement data gets entered into the personal health coach 300. Also, in this way, a manufacturer of such devices can start with an already existing device and add support for a key with minimal effort and cost.

The personal health coach 300 further comprises wireless communication keys 370, 371, and 372. The keys 370, 371, and 372 have all been assigned to the base station 310, which implies that each of the keys is able to establish a wireless communication with the transceiver 313 of the base station 310, provided that such a key gets attached to a suitable device. Each of the keys 370, 371, and 372 holds a unique identification, as already described earlier. Via the identification, each of the keys 370, 371, and 372 has been associated with a respective user of the personal health coach 300, and has been issued to that user.

Whenever a user of the personal health coach 300 wants to add physical measurement data, the user attaches his key to the measurement device by which that data is to be provided. In FIG. 3, a first user has attached his key 370 via connector 321 to device 320 in order to have his body weight measurement wirelessly communicated via a connection 380 to the base station 310, for storage in the database 314. A second user has attached his key 371 via connector 341 to device 340 in order to have his blood pressure measurement wirelessly communicated via a connection 381 to the base station 310, also for storage in the database 314. A third user has not currently attached his key 372 to any of the devices. The devices 230, 250, and 260 have no key attached to it, and have therefore not a wireless connection with the base station 310 at this time.

For the personal health coach 300, the measurement devices 320, 330, 340, 350, and 360 may exhibit different wireless communication characteristics. The devices 320, 330, and 340 in principle perform a single measurement only. Hence, a single, not very long lasting, wireless connection with the base station 310 to communicate this measurement may be sufficient. The devices 350 and 360 on the other hand perform a more or less continuous measurement and therefore require a wireless connection with the base station 310 that has a more or less periodic or perhaps even continuous character.

FIG. 4 illustrates, in a schematic way, the most important parts of a third embodiment of the system according to the invention, making use of a pair of wireless communication keys. A system 400 comprises a pair of wireless communication keys, namely a key 430 and a key 440. Each of the keys 430 and 440 comprises a respective transceiver 432 and 442. The keys 430 and 440 have been assigned to each other, which implies that the transceivers 432 and 442, contained in the respective keys, are able to establish a wireless connection with each other, provided that both keys get attached to a device. Besides the keys 430 and 440, the system 400 comprises devices 410 and 420, both of them suited for operation with a key. In particular, both devices 410 and 420 comprise a respective control unit 414 and 424 for operating an attached key.

In the system 400, the wireless communication key 430 has been attached to the device 410 by means of a connection 436. Similarly, the key 440 has been assigned to the device 420 by means of a connection 446. It is therefore possible for the control units 414 and 424 of the respective devices 410 and 420 to operate the respective keys 430 and 440, and in particular the respective transceivers 432 and 442, and in this way establish a wireless connection 450 between the devices 410 and 420.

FIG. 5 illustrates, in a schematic way, the most important parts of a remote video camera system comprising a fourth embodiment of the system according to the invention, also making use of a pair of wireless communication keys. A remote video camera system may be used for monitoring purposes in and around a home, for example to keep an eye on a baby while the baby is asleep in a room, or for surveillance of a front door or entrance gate.

Shown in FIG. 5 is a remote video camera system 500 comprising devices 510, 520, 530, and 540, and extended over locations 501-504 of a home. Location 501 may be a bedroom, containing a first TV-set 510. Location 502 may be a front door location, where a first video camera 520 has been placed to monitor the front door. Location 503 may be a living room, but could also be a kitchen, where a second TV-set is located. Location 504 may be a bedroom, possibly for a baby, where a second video camera 540 has been installed. When the video camera 520 or 540 gets connected with the TV-set 510 or 530, video images produced by the camera may be made visible on the TV-set. In terms of the present invention, each of the devices 510, 520, 530, and 540 comprises a device that does not have a transceiver of its own and is instead constructed to use a wireless communication key. For the devices 510, 520, 530, and 540, a key is to be attached via the respective connectors 511, 521, 531, and 541. This is only shown in a symbolic way in FIG. 5.

The remote video camera system 500 further comprises a pair of wireless communication keys, namely a key 550 and a key 560. The keys 550 and 560 have been assigned to each other, which implies that these keys are able to establish a wireless connection with each other, provided that both keys get attached to a suitable device.

FIG. 5 reflects a situation in which a user of the remote video camera system 500, who is located in the living room 503, wishes to keep an eye on for example a young child, who is asleep in the bedroom 504. The user may be a parent or a baby-sit, taking care of the child at that time. To accomplish the monitoring of the child, the user has attached the wireless communication key 550 to the TV-set 530, via the connector 531, and the key 560 to the video camera 540, via the connector 541. As a result, a wireless connection 570 gets established between the camera 540 and the TV-set 530, which can then be used to communicate the video images from the camera 540 to the TV-set 530, for viewing there by the user. Because of the continuous character of the video images, the communication will most likely be continuous too.

Although not shown directly in FIG. 5, the remote video camera system 500 offers various other possibilities as well. For example, when the user decides to move from the living room 503 to the bedroom 501, the user can simply detach the wireless connection key 550 from the TV-set 530, carry the key 550 over to the bedroom 501, and there attach the key 550 to the TV-set 510, via the connector 511. At that point in time, a wireless connection between the video camera 540 and the TV-set 510 gets established via which the video images from the camera 540 can now be communicated to the TV-set 510, for viewing there by the user. Another possibly offered concerns movement of the wireless communication key 560, from the camera 540 in the bedroom 504 over to the camera 520 located near the front door position 502. Assuming the key 550 is still attached to the TV-set 530, as shown in FIG. 5, now a wireless connection between the camera 520 and the TV-set 530 gets established via which the video images from the camera 520 can now be communicated to the TV-set 530, for viewing there by the user.

FIG. 6 illustrates, in a schematic way, a first embodiment of the method according to the invention, making use of a fixed endpoint device. Throughout the discussion of FIG. 6 further reference is made to FIG. 2 by way of some of the reference numerals of FIG. 2. The method starts in a situation where a wireless connection between a first device 220 and a second device 210 is desired.

In a first step 610 a wireless communication key 250 is provided. This key comprises a first transceiver 252 conceived for communicating wirelessly with a second transceiver 212 included in the second device 210. The key 250 may have been obtained together with the second device 210, for example when purchased. The key 250 may also have been obtained separately, or perhaps together with the first device 220, and thereafter assigned to the second device 210.

In a second step 620 the wireless communication key 250 is operatively attached to the first device 220, and thereby prepared for use by the first device 220.

In a third and last step 630 the first device 220 uses the wireless communication key 250 for establishing a wireless connection 280 between the first device 220 and the second device 210. This reflects the situation as shown in FIG. 2.

FIG. 7 illustrates, in a schematic way, a second embodiment of the method according to the invention, making use of a pair of wireless communication keys. Throughout the discussion of FIG. 7 further reference is made to FIG. 4 by way of some of the reference numerals of FIG. 4. The method starts in a situation where a wireless connection between a first device 430 and a second device 440 is desired.

In a first step 710 a pair of wireless communication keys, namely a first key 430 and a second key 440, is provided. Each one of this pair of keys comprises a respective transceiver 432 and 442, conceived for communicating wirelessly with the transceiver included in the other key. The pair of keys may have been obtained together with one or both of the devices 430 and 440, for example when purchased. The pair of keys may also have been obtained separately. It may even be the case that the individual keys 430 and 440 of the pair of keys have been obtained separately, and thereafter assigned to each other.

In a second step 720 the wireless communication keys 430 and 440 are operatively attached to the respective devices 410 and 420, and thereby prepared for use by the devices 410 and 420.

In a third and last step 730 the devices 410 and 420 use the respective wireless communication keys 430 and 440 for establishing a wireless connection 450 between the devices 410 and 420. This reflects the situation shown as in FIG. 4.

It will be clear that apart from the aforementioned embodiments the invention may be beneficial by way of many other embodiments. A first example concerns the use of a TV-set as a fixed endpoint device, with content source devices like a video recorder, a set-top box, or a DVD player equipped for use with a key, and with the key assigned to the TV-set. A second example concerns the use of a portable audio device equipped for use with a key. With a second such audio device nearby, a pair of keys may be used to wirelessly connect the two audio devices, for example to exchange music. The presence (or absence) of any such keys provides for clear user control and feedback as to which whether the audio devices are able to communicate wirelessly at any particular moment in time. A third example concerns the use of a pair of keys to wirelessly connect a digital camera to a printer device. From the above it will be clear that the invention offers a very convenient and flexible way for communicating wirelessly between devices.

The invention can be summarized as follows:

The invention relates to a method and a system (200) for communicating wirelessly between devices. Wireless communication can be a very appropriate way of interconnecting nearby devices, such as devices located within a home. However, equipping all devices with a wireless transceiver may not be desirable. Furthermore, an ordinary user should be able to connect devices in a straightforward and convenient way. The invention addresses these issues by means of a wireless communication key (250, 260, 270). This is a key-like object equipped with a transceiver. A key can be attached to a device (220, 230, 240) for which a wireless connection is required. A key may have to be powered by the device to which it gets attached and can then establish a wireless connection (280, 282) with another device. The other device is determined by the key used. A key may be associated with a fixed endpoint device (210), permanently equipped with a transceiver (212). Alternatively, a key may be associated with a second key that is to be attached to the other device.

1. A method for communicating wirelessly between a first device and a second device, characterized in that the method comprises
a first step of providing a wireless communication key, comprising a first transceiver conceived for communicating wirelessly with a second transceiver included in the second device,
a second step of operatively attaching the wireless communication key to the first device,
a third step of the first device utilizing the attached wireless communication key for establishing wireless communication between the first device and the second device.

2. A method according to claim 1, characterized in that the wireless communication key contains a unique identification and the third step comprises a sub-step of communicating this identification to the first device and the second device for purposes of identification and/or authorization.

3. A method for communicating wirelessly between a first device and a second device, characterized in that the method comprises
a first step of providing a first wireless communication key and a second wireless communication key, each one of said keys comprising a transceiver conceived for communicating wirelessly with the transceiver included in the other key,
a second step of operatively attaching the first wireless communication key to the first device and the second wireless communication key to the second device,
a third step of the first device and the second device utilizing said respective attached wireless communication keys for establishing wireless communication between the first device and the second device.

4. A system arranged for communicating wirelessly between a first device and a second device, characterized in that the system comprises
a wireless communication key, comprising a first transceiver conceived for communicating wirelessly with a second transceiver included in the second device,
first means for operatively attaching the wireless communication key to the first device,
second means for the first device utilizing the attached wireless communication key for establishing wireless communication between the first device and the second device.

5. A personal health coach comprising a system according to claim 4.

6. A system arranged for communicating wirelessly between a first device and a second device, characterized in that the system comprises
a first wireless communication key and a second wireless communication key, each one of said keys comprising a transceiver conceived for communicating wirelessly with the transceiver included in the other key,
first means for operatively attaching the first wireless communication key to the first device,
second means for operatively attaching the second wireless communication key to the second device,
third means for the first device and the second device utilizing said respective attached wireless communication keys for establishing wireless communication between the first device and the second device.

7. A remote video camera system comprising a system according to claim 6.
